(19) United States
(12) Patent Application Publication
(10) Pub. No.: US 2015/0100366 A1
(43) Pub. Date: Apr. 9, 2015

(54) SYSTEM AND METHOD FOR MANAGING A LAW ENFORCEMENT INVESTIGATION

(71) Applicant: immixSolutions, Inc., McLean, VA (US)

(72) Inventors: Jerahd HOLLIS, Leesburg, VA (US); Claude DAVENPORT, Warrenton, VA (US); Derek SLEEPER, Lansdowne, VA (US); Phill MAGARO, Hume, VA (US)

(21) Appl. No.: 14/048,624

(22) Filed: Oct. 8, 2013

(51) Int. Cl. G06Q 10/06; G06Q 50/26

(52) U.S. Cl. CPC G06Q 10/06313; G06Q 50/26
USPC 705/7.23

(57) ABSTRACT

The present disclosure relates to a method and system for managing a law enforcement investigation, such as a civil or criminal investigation, using a computing system. A disclosed method includes receiving first entity data associated with a first investigation tracking module, comparing the first entity data to a set of investigation data associated with a second investigation tracking module, and, in response to the first entity data matching second entity data associated with the second investigation tracking module, generating a link in the first investigation tracking module to the second entity data associated with the second investigation tracking module. A disclosed system includes investigation tracking logic operative to perform the disclosed method.

### FIELD OF THE DISCLOSURE

The present disclosure is generally related to the field of law enforcement investigation management, and more particularly to methods and systems for tracking and linking investigation data across a plurality of investigation tracking modules.

### BACKGROUND

Case management tools are used by investigators, such as law enforcement agents, to assist in the management of a law enforcement investigation. Case management tools may include a software program executed on a computing system that allows investigation data to be stored and organized for a particular case or investigation. Investigators often pull information from multiple data management sites by logging into each site separately, identifying relevant information, and gathering this data by hand into their own case management tool. Documents such as search warrants, activity reports, and summons are generated manually by each investigator and collated by their management team. This creates a labor intensive and redundant investigative process and decreases efficiencies as well as the number of cases an agent can effectively manage. Further, investigation information gathered by one agency or jurisdiction that is relevant to another agency's investigation may never be seen or accessed by the other agency, resulting in missed information and/or duplication of efforts by multiple agencies.

### SUMMARY OF EMBODIMENTS OF THE DISCLOSURE

In an exemplary embodiment of the present disclosure, a management method for a law enforcement investigation carried out by one or more computing devices is provided. The method includes executing, by investigation tracking logic, a first investigation tracking module of a plurality of investigation tracking modules. Each investigation tracking module is operative to track a set of investigation data for a different law enforcement investigation. Each set of investigation data includes entity data. The method further includes receiving first entity data associated with the first investigation tracking module, and comparing the first entity data to investigation data associated with a second investigation tracking module. In response to the first entity data matching second entity data associated with the second investigation tracking module, the method includes generating, by the investigation tracking logic, a link in the first investigation tracking module to the second entity data associated with the second investigation tracking module.

In another exemplary embodiment of the present disclosure, a management system for a law enforcement investigation is provided. The system includes investigation tracking logic operative to execute a first investigation tracking module of a plurality of investigation tracking modules. Each investigation tracking module is operative to track a set of investigation data for a different law enforcement investigation, and each set of investigation data includes entity data. The investigation tracking logic is operative to receive first entity data associated with the first investigation tracking module and to compare the first entity data to investigation data associated with a second investigation tracking module. In response to the first entity data matching second entity data associated with the second investigation tracking module, the investigation tracking logic is operative to generate a link in the first investigation tracking module to the second entity data associated with the second investigation tracking module.

In yet another exemplary embodiment of the present disclosure, a non-transitory computer-readable medium is provided including executable instructions such that when executed by at least one processor cause the at least one processor to execute a first investigation tracking module of a plurality of investigation tracking modules. Each investigation tracking module is operative to track a set of investigation data for a different law enforcement investigation, and each set of investigation data includes entity data. The at least one processor is further caused to receive first entity data associated with the first investigation tracking module and to compare the first entity data to investigation data associated with a second investigation tracking module. The at least one processor is further caused to, in response to the first entity data matching second entity data associated with the second investigation tracking module, generate a link in the first investigation tracking module to the second entity data associated with the second investigation tracking module.

### BRIEF DESCRIPTION OF THE DRAWINGS

The invention will be more readily understood in view of the following description when accompanied by the below figures and wherein like reference numerals represent like elements:

FIG. 1 is a block diagram illustrating an exemplary investigation management environment according to some embodiments including multiple computing devices in communication with a hash library server;

FIG. 2 is a block diagram illustrating an exemplary computing device in communication with the hash server of FIG. 1 according to some embodiments, the computing device including investigation tracking logic operative to track and link investigation data associated with a plurality of investigations;

FIG. 3 is a flow chart of an exemplary method of operation of the investigation tracking logic of FIG. 2 for performing a deconfliction process;

FIG. 4 is a flow chart of exemplary detailed method of operation of the computing device of FIG. 2 for performing a deconfliction process;

FIG. 5 illustrates a home screen of an exemplary graphical user interface provided by the investigation tracking logic of FIG. 2 and accessed by a first user;

FIG. 6 illustrates a Create New Investigation screen of the exemplary user interface of FIG. 5;

FIG. 7 illustrates an Investigation Tracking Module screen of the exemplary user interface of FIG. 5 for accessing and modifying investigation data associated with an investigation tracking module;

FIG. 8 illustrates the Investigation Tracking Module screen of FIG. 7 including an Add Sub Entities tab for adding a new entity to the investigation module;

FIG. 9 illustrates a Create New Person screen of the exemplary user interface of FIG. 5 for adding a new person entity to the investigation tracking module of FIG. 7;

FIG. 10 illustrates an Entity screen of the exemplary user interface of FIG. 5 for accessing and modifying investigation data associated with an entity of the investigation tracking module of FIG. 7;

FIG. 11 illustrates a Create New Business screen of the exemplary user interface of FIG. 5 for adding a new business entity to the investigation tracking module of FIG. 7;

FIG. 12 illustrates a Create New Persona screen of the exemplary user interface of FIG. 5 for adding a new persona entity to the investigation tracking module of FIG. 7;

FIG. 13 illustrates the Investigation Tracking Module screen of FIG. 7 listing the newly created entities under the All Sub Entities tab;

FIG. 14 illustrates an Assign Permissions screen of the Investigation Tracking Module screen of FIG. 7 for assigning user permissions to the investigation tracking module;

FIG. 15 illustrates an Investigation Tracking Module screen of an exemplary graphical user interface provided by the investigation tracking logic of FIG. 2 and accessed by a second user for accessing and modifying investigation data associated with another investigation tracking module;

FIG. 16 illustrates a Create New Person screen for adding a new person entity to the investigation tracking module of FIG. 15;

FIG. 17 illustrates a Deconfliction Notification of the investigation tracking module of FIG. 15 in response to the detection of a matching entity;

FIG. 18 illustrates a linked Person Entity screen of the investigation tracking module of FIG. 15 for accessing and modifying investigation data associated with the person entity created with the investigation tracking module of FIG. 7;

FIG. 19 illustrates the linked Person Entity screen of FIG. 18 including a listing of deconflictions associated with the linked person entity;

FIG. 20 illustrates the Investigation Tracking Module screen of FIG. 15 illustrating a generated link to the person entity of the investigation tracking module of FIG. 7;

FIG. 21 illustrates the home screen of the exemplary user interface of FIG. 5 showing a listing of deconflictions associated with the first user;

FIG. 22 illustrates the Investigation Tracking Module screen of FIG. 7 including a listing of deconflictions associated with the investigation tracking module; and

FIG. 23 illustrates the Investigation Tracking Module screen of FIG. 7 including a listing of image hashes associated with the investigation tracking module.

### DETAILED DESCRIPTION

The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the embodiments, various logic may be implemented in any appropriate fashion and would remain in accordance with the embodiments herein disclosed.

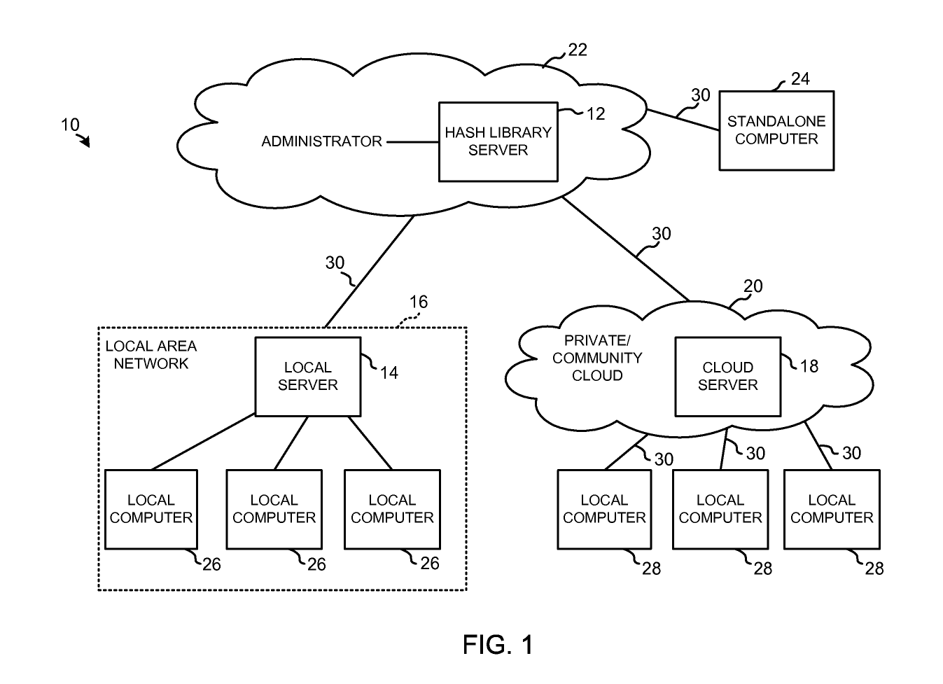

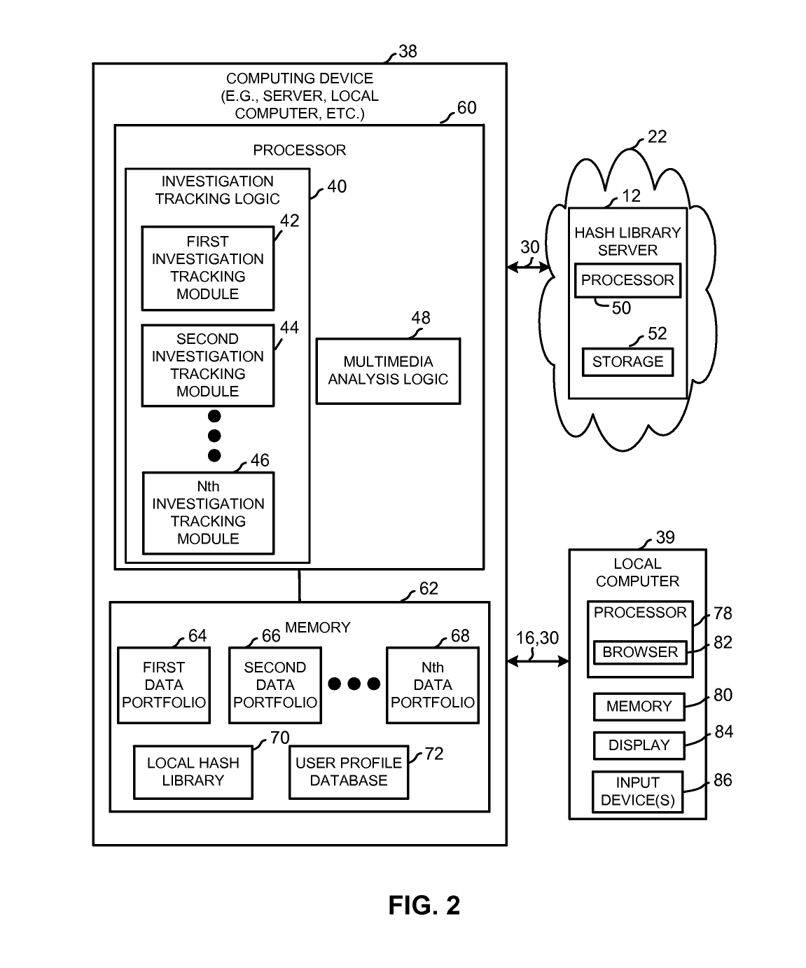

FIG. 1 illustrates an exemplary computing environment 10 according to various embodiments of the present disclosure that is configured to manage investigation information for multiple law enforcement investigations. Computing environment 10 is operative to track and link investigation data for multiple law enforcement agencies across multiple jurisdictions, thereby providing an integrated system adapted for collaborative tracking and information collection efforts. Computing environment 10 includes multiple computing devices and networks, illustratively including a local server 14 on a local area network 16, a cloud server 18 on a cloud network 20, and a standalone computer 24. Local server 14, cloud server 18, and standalone computer 24 are each configured to execute the investigation tracking logic 40 described herein (FIG. 2). A hash library server 12 is in communication with the computing devices via one or more networks. Hash library server 12 is illustratively provided in an internet-hosted environment 22 to communicate with local server 14 via a wide-area network 30, such as an Internet-based network 30, or other suitable network. In one embodiment, hash library server 12 is a cloud-based system including cloud storage (e.g., storage 52 of FIG. 2). Other suitable networks may be provided for communication between devices. Further, computing environment 10 may include additional computing devices and networks in communication with hash library server 12 and operative to execute investigation tracking logic 40 for managing additional investigations.

The local area network 16 may be provided in a business, home, or other suitable environment or site. For example, local area network 16 may be provided in an office or building complex of a law enforcement agency. Multiple local computers 26 (three computers 26 for illustrative purposes) communicate with the local server 14 over local area network 16. For example, a computer 26 may belong to one or more law enforcement agents for accessing and utilizing the investigation tracking logic 40 and hash library server 12 described herein.

Cloud server 18 is illustratively provided in a cloud-based or other Internet-based environment 20. Cloud server 18 may be private, such as accessible only by computer devices within a particular building, agency, or jurisdiction. Cloud server 18 may also be accessible by a community, such as a law enforcement community, and shared across multiple jurisdictions and/or agencies. Multiple local computers 28 (three computers 28 for illustrative purposes) communicate with cloud server 18 over one or more networks 30 (e.g., Internet-based network, other web-based network, etc.) for accessing and utilizing the investigation tracking logic 40 and hash library server 12.

Computers 24, 26, 28 may be, for example, tablet computers, laptop computers, desktop computers, mobile devices, smart phones, or other computing devices. In the illustrated embodiment, a standalone computer 24 communicates directly with hash library server 12 via one or more networks, such as the wide-area network 30. Local computers 26, 28 may also be configured to communicate directly with hash library server 12 in some embodiments.

FIG. 2 illustrates an exemplary computing device 38 including investigation tracking logic 40. Computing device 38 may include standalone computer 24, local server 14, or cloud server 18 of FIG. 1, or any other computing device including a processor 60 and memory 62 and configured to access hash library server 12. Processor 60 includes one or more processing devices that is operative to execute software or firmware stored in memory 62. Memory 62 includes one or more physical memory locations and may be internal or external to processor 60 and/or to the computing device 38. Investigation tracking logic 40 and multimedia analysis logic 48 each includes software and/or firmware stored in memory 62 executed by processor 60. Multimedia analysis logic 48 is operative to analyze and compare multimedia investigation data, such as videos, images, and metadata, from multiple investigation databases to detect similar or matching multimedia. In some embodiments, common images and videos are matched even if some differences exist, such as differences in resolution, file type, image size, etc. Investigation tracking logic 40 is configured to delete duplicate images and provide a link to common images between multiple investigations based on the multimedia analysis performed by logic 48.

Investigation tracking logic 40 includes a plurality of investigation tracking modules, illustratively including a first investigation tracking module 42, a second investigation tracking module 44, and one or more Nth investigation tracking modules 46. In some embodiments, each tracking module executed by investigation tracking logic 40 corresponds to a different law enforcement investigation. In particular, each tracking module is associated with a different set of investigation data (i.e., data portfolio) stored in memory 60, and each set of investigation data corresponds to the information gathered and stored for a particular law enforcement investigation. Memory 60 illustratively includes a first data portfolio 64 corresponding to the first tracking module 42, a second data portfolio 66 corresponding to the second tracking module 44, and an Nth data portfolio(s) 68 corresponding to the Nth tracking module(s) 46.

In the illustrated embodiment, investigation data includes, for example, data related to persons, personas (e.g., email address, screen name, social website account names or ID, chat room name, other online identity, nickname), businesses, home or business addresses, websites, Internet Protocol (IP) addresses, images, videos, vehicles, payment accounts, and any other investigation based documents and data. Memory 60 also includes a user profile database 72 for storing a plurality of user profile data, thereby allowing computing device 38 to track and manage user access to investigation tracking logic 40 and hash library server 12 (e.g., users of a local computer 39 or other device).

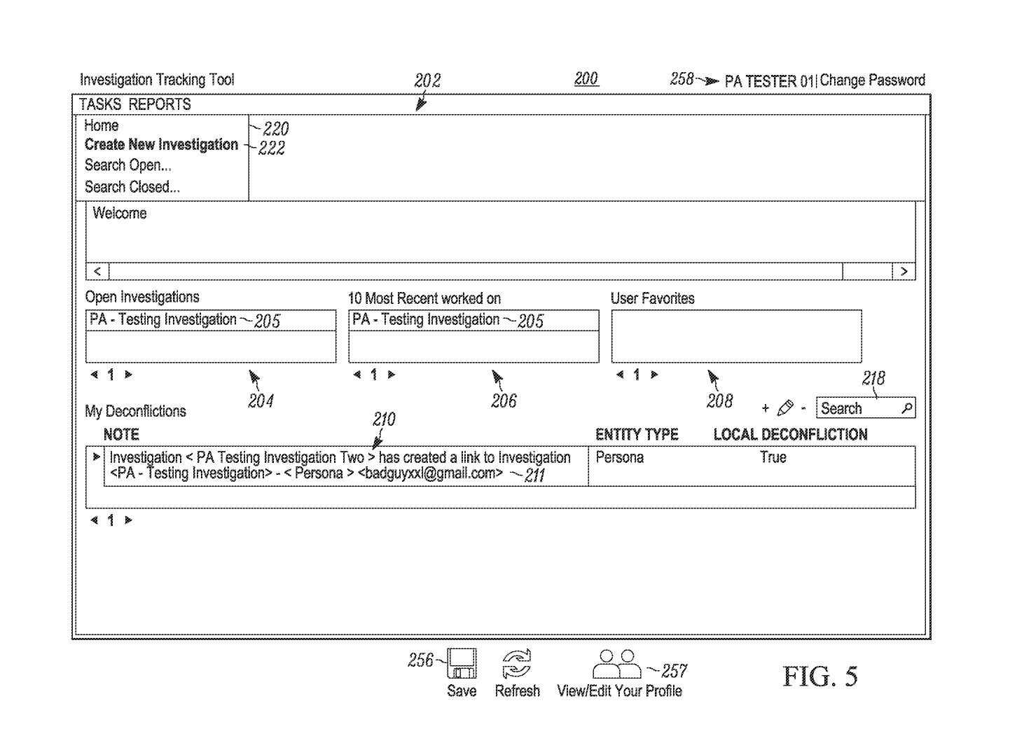

Local computer 39 is in communication with computing device 38 for accessing investigation tracking logic 40 and hash server 12. Local computer 39 may include local computer 26, 28 of FIG. 1 or any other computing device including a processor 78 and memory 80. Processor 78 includes one or more processing devices that is operative to execute software or firmware stored in memory 80. Memory 80 includes one or more physical memory locations and may be internal or external to processor 78. A web-browser 82, which includes software and/or firmware code executed by processor 78, is used to access (i.e., via network 16, 30) a graphical user interface provided by investigation tracking logic 40 and to display the graphical user interface on a display 84. See, for example, graphical user interface 200 illustrated in FIGS. 5-23. Computer 39 also includes one or more user input devices 86, such as a mouse, keyboard, touchpad, touchscreen, or other suitable device for user input.

As illustrated in FIG. 2, hash library server 12 includes a processor 50 and storage 52. In one embodiment, storage 52 includes cloud-based storage and may include multiple physical storage devices and locations. Processor 50 includes logic operative to manage the storage of investigation data, in particular hash values, provided from multiple computing devices (e.g., devices 14, 18, 24, 38) of environment 10 of FIG. 1, as described herein. In one embodiment, computing device 38 also stores hash values in a local hash value library 70 stored in memory 62.

In the illustrated embodiment, investigation tracking logic 40 is operative to perform a deconfliction process to reduce the likelihood of duplicate investigation data being entered and tracked in different investigations. The deconfliction allows common investigation information, such as entity data, for example, to be shared among multiple agencies and jurisdictions, thereby facilitating collaboration between the agencies and jurisdictions in the investigation tracking efforts. As described herein, investigations may track various entities associated with the investigation. Exemplary entities include persons, personas, businesses, home or business addresses, websites, Internet Protocol (IP) addresses, images, videos, vehicles, payment accounts, or any other types of entities associated with a law enforcement investigation. Investigation tracking logic 40 is operative to detect when a common entity is being tracked between two or more investigation tracking modules, including investigation tracking modules from any agency or jurisdiction throughout the world that is connected to the computing environment 10 of FIG. 1. Further, common entity data may be matched and linked between both present investigations and past investigations (e.g., closed investigations).

In the illustrated embodiment, investigation tracking logic 40 detects common entity data between investigation tracking modules by assigning a hash value to each entity entered into an investigation tracking module. For example, when a user enters entity data to an investigation tracking module (e.g., text entry or image upload), investigation tracking logic 40 automatically calculates and assigns a hash value to the entity data that is based on, for example, the text string or the electronic file content (e.g., image or file content) of the entity data. The resulting hash value is stored in storage 52 of hash library server 12 and is linked to the corresponding entity data. Alternatively, investigation tracking logic 40 may send the entity data to hash library server 12, and processor 50 of hash library server 12 may calculate, assign, and store the hash value and associated entity data. As such, a database of hash values and the associated entity data are stored in hash library server 12. In one embodiment, the hash values further serve to anonymize the investigation data. When new entity data is entered in an investigation tracking module that is linked to hash library server 12, the corresponding investigation tracking logic 40 checks the hash value of the new entity data with the hash values stored at server 12 to determine if the entity data (or similar entity data) already exists in a different investigation. As described herein, investigation tracking logic 40 is operative to link the prior created entity data from the different investigation to the current investigation tracking module, depending on user approval and proper access rights. Other suitable types of investigation data besides entity data may be deconflicted.

In one embodiment, text entity data is matched by investigation tracking logic 40 in the deconfliction process when the text strings are identical. In another embodiment, text entity data is matched by investigation tracking logic 40 in the deconfliction process when the text strings are substantially similar, such as when a majority of the text characters are the same in the two entities. Image/video data may be matched by investigation tracking logic 40 when a majority of the image/video content is common between two images, based on the analysis performed by multimedia analysis logic 48. Other thresholds of matching entity data in the deconfliction process may be implemented. In the illustrated embodiment, investigation tracking logic 40 cooperates with multimedia analysis logic 48 to determine when two or more images, video, or metadata match for deconfliction purposes.

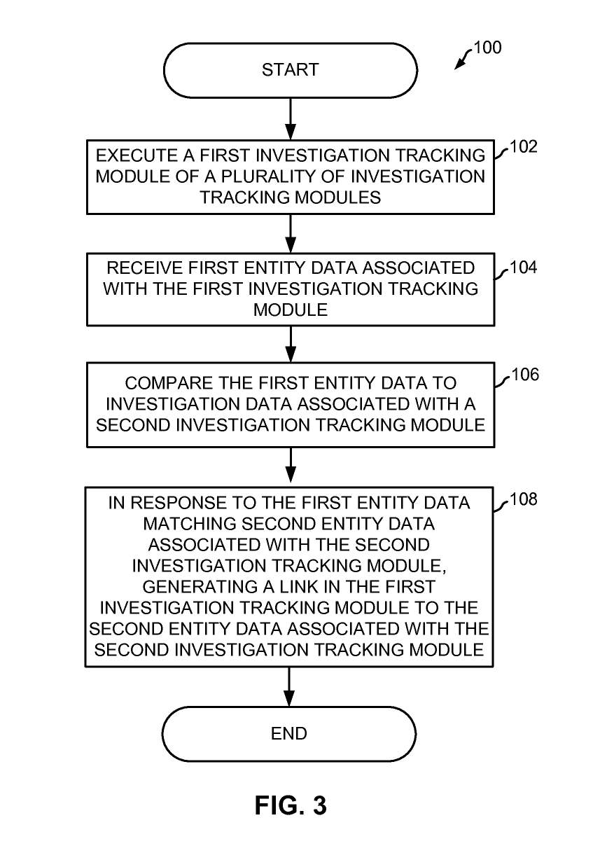

FIG. 3 illustrates a flow diagram 100 of an exemplary deconfliction operation performed by investigation tracking logic 40 of FIG. 2. Reference is made to FIG. 2 throughout the description of FIG. 3. At block 102, investigation tracking logic 40 executes a first investigation tracking module 42 of a plurality of investigation tracking modules. At block 104, investigation tracking logic 40 receives first entity data associated with the first investigation tracking module 42. In some embodiments, the first entity data comprises a text string received via input device 86 of local computer 39 including, for example, the name of a person, a business name, a persona, or an address (e.g., web, email, IP, home or business, etc.), or any other suitable data describing an entity of the investigation.

At block 106, investigation tracking logic 40 compares the first entity data to investigation data associated with a second investigation tracking module. The second investigation tracking module may include a locally executed module (e.g., module 44 or 46) or a remotely executed module located on a network of another jurisdiction or agency. In the illustrated embodiment, investigation tracking logic 40 compares the first entity data with the investigation data of the second investigation tracking module by accessing hash library server 12 to search for a second hash value of second entity data (e.g., person, business, address, persona, etc.) that corresponds to the first hash value generated for the first entity data.

At block 108, in response to the first entity data matching second entity data associated with the second investigation tracking module, investigation tracking logic 40 generates a link in the first investigation tracking module 42 to the second entity data associated with the second investigation tracking module. In one embodiment, the link includes a selectable web link in the first investigation tracking module 42 that provides a user access (e.g., read and/or write access) via local computer 39 to the second entity data of the second investigation tracking module. As a result of the deconfliction, the second entity data is linked to two investigations and is viewable and modifiable by agents in both investigations. In one embodiment, the link is generated in response to verification by the investigation tracking logic 40 that a current user of the first investigation tracking module has access rights to investigation data associated with the second investigation tracking module. In one embodiment, the first entity data is deleted by logic 40 upon creating the link to the second entity data. In one embodiment, logic 40 further provides a notification (e.g., a message, link, or other alert) to the second investigation tracking module that the second entity data matches first entity data entered in the first investigation. As such, a user of the second investigation tracking module is notified that another investigation is tracking potentially the same entity.

FIGS. 5-23 illustrate an exemplary user interface 200 provided by investigation tracking logic 40 that provides user access and manipulation of investigation tracking modules associated with different investigations. User interface 200 is illustratively a web-based, graphical user interface 200 that includes multiple selectable screens configured for display on a display, such as display 84 of local computer 39 (FIG. 2). In one embodiment, user interface 200 is accessed via a web browser, such as the web browser 82 of computer 39. Other suitable user interfaces may be provided, such as a native user interface application, a command line driven interface, a programmable API, or another other type or combination of interfaces. User interface 200 includes selectable data, such as selectable inputs, fields, modules, tabs, drop-down menus, boxes, and other suitable selectable data, that are linked to and provide input to investigation tracking logic 40. In one embodiment, the selectable data of user interface 200 is rendered in a manner that allows it to be individually selectable. For example, the selectable data is selected by a user with a mouse or touchpad pointer, by touching a touchscreen of user interface 200, by pressing keys of a keyboard, or by any other suitable selection mechanism. Selected data may result in the data being highlighted or checked, for example, and a new screen, menu, or pop-up window may appear based on selection of some selectable data (e.g., modules, drop-down menus, etc.).

In the examples illustrated throughout FIGS. 5-23, the investigation tracking system provided with investigation tracking logic 40 and hash server 12 is described with reference to criminal investigations. Any other types of investigations may be utilized with the investigation tracking system, including civil investigations, for example. Other examples of applications for the investigation tracking system are also applicable, and the disclosure is not limited to a criminal or civil law enforcement application.

Referring to FIG. 5, an exemplary home screen 202 of the graphical user interface 200 is illustrated according to some embodiments. Home screen 202 is displayed upon proper user credentials, such as username and password, being entered via user interface 200 and verified by investigation tracking logic 40, i.e., by checking user profile database 72 (FIG. 2). A first user 258 is illustratively logged into graphical user interface 200. A user profile may be created/edited for user 258 upon selection of input 257 in home screen 202, including name, position, supervisor, division, address, phone numbers, and emails of the user, for example.

Home screen 202 lists investigations that are currently open or pending in listing 204, the most recently accessed investigations in listing 206, and the investigations marked “favorite” by the user in listing 208. Each investigation in listings 204, 206, 208 is selectable to allow the user to access the corresponding investigation tracking module (e.g., module 42, 44, 46 of FIG. 2). Home screen 202 also displays the deconflictions associated with investigation modules accessed by the user in table 210. Each listed deconfliction includes a name or description, the entity type, and whether the deconfliction is local or not (shown as true or false). A local deconfliction is a deconfliction of entity data between investigation tracking modules of local investigations (e.g., the same agency or jurisdiction), while a non-local deconfliction is between the local agency or jurisdiction and an external agency or jurisdiction. Deconflictions may also be searched via search field 218. While only a single deconfliction 211 and a single investigation module 205 is listed in the exemplary FIG. 5 for illustrative purposes, additional deconflictions and modules may be listed and accessed from home screen 202.

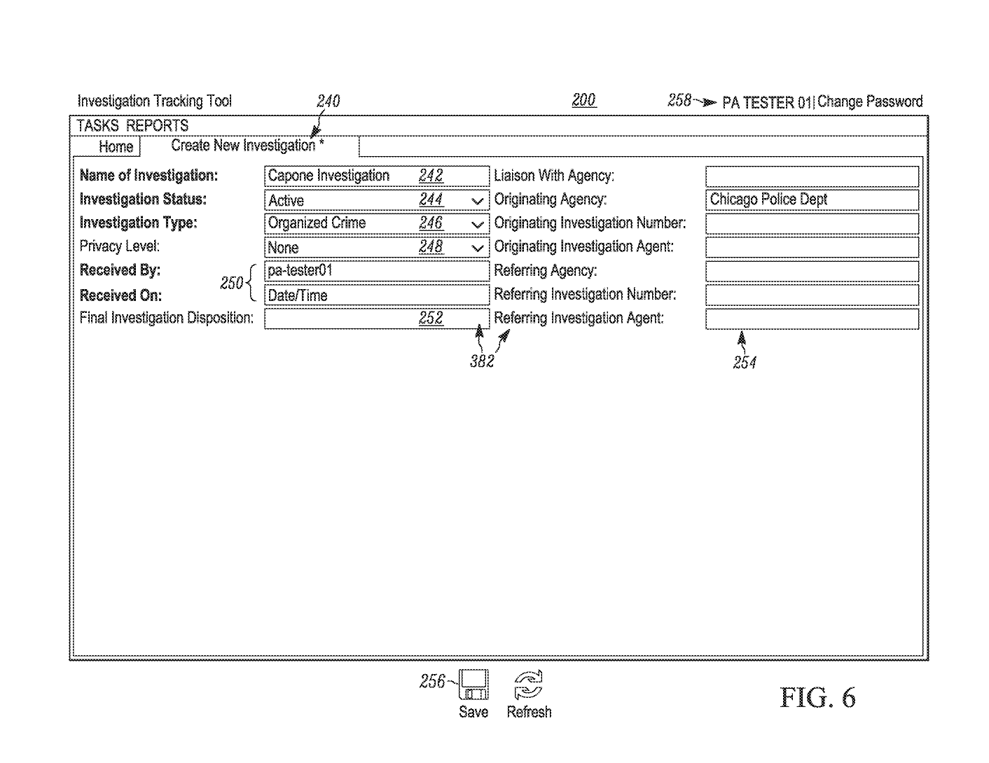

To create an investigation module for a new investigation, the Create New Investigation input 222 is selected from drop down menu 220, which causes user interface 200 to open the Create New Investigation tab 240 illustrated in FIG. 6. A user inputs various data describing the new investigation in fields 382 under tab 240. In particular, the name of the investigation (field 242), the investigation status (field 244), and the investigation type (field 246) may be entered. Exemplary investigation statuses include active, pending, closed, and transferred to a different agency. Exemplary investigation types include conspiracy, child pornography, assist or accessory, elected official, high technology, intellectual property, organized crime, road rage, terrorism involvement, white collar crime, or any other suitable types of civil or criminal investigations.

The privacy level of the investigation may be set via drop down menu 248. Exemplary privacy settings include allowing access only to the owner(s) (which may include all users with access permissions to the module) of the investigation, to specific users or agencies, or to all users and investigations. For example, an owner may include one or more investigators who are assigned to that investigation. As such, a privacy setting of “owner” may provide read/write access to all designated investigators assigned to that investigation as well as to the investigators' managers, for example. In one embodiment, an administrator of the investigation module designates which users (e.g., investigators) are granted “owner” access rights to the corresponding investigation module. In one embodiment, if the privacy setting allows only the owners to access the investigation, deconfliction with other investigation tracking modules (e.g., modules administered by external agencies) is not available for that investigation. In this embodiment, investigation tracking modules that restrict privacy settings to owner-only access will not have deconfliction capabilities of the investigation tracking logic 40 with other investigation tracking modules. The user creating the investigation and the date/time is displayed in fields 250. If the investigation has been resolved or closed, the final disposition of the investigation is entered in field 252. Additional investigation information may be entered in fields 254, including the liaison with the agency, the originating agency setting up the investigation, the originating investigation number and agent, and any referring agency, investigation number, and agent. Other suitable investigation information may be entered.

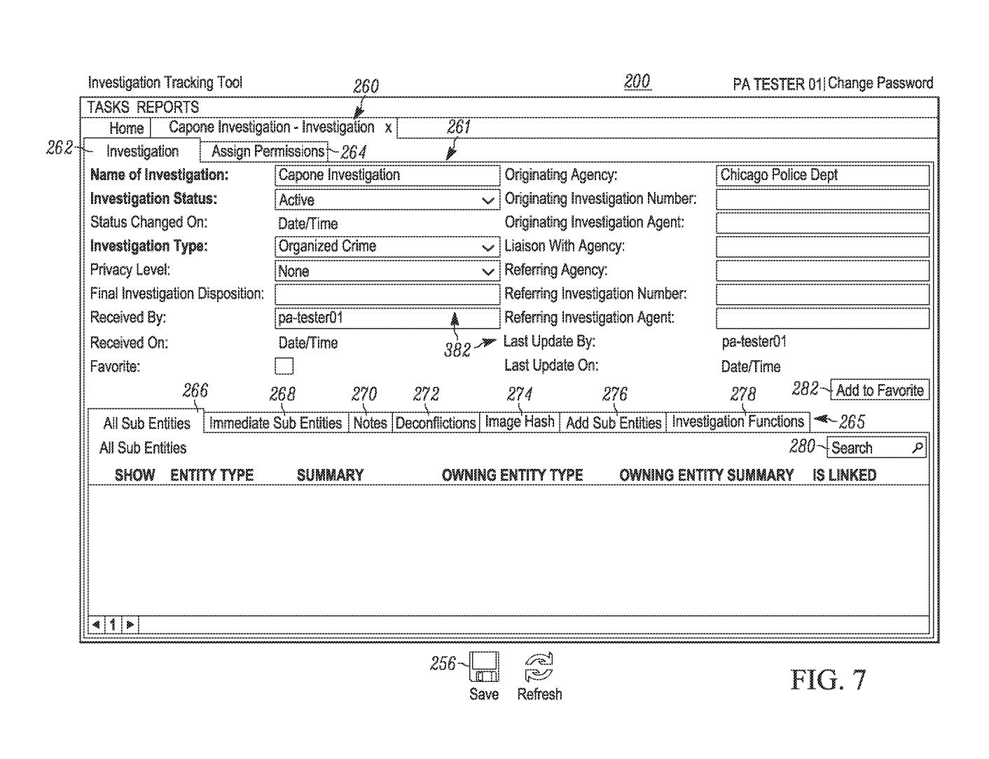

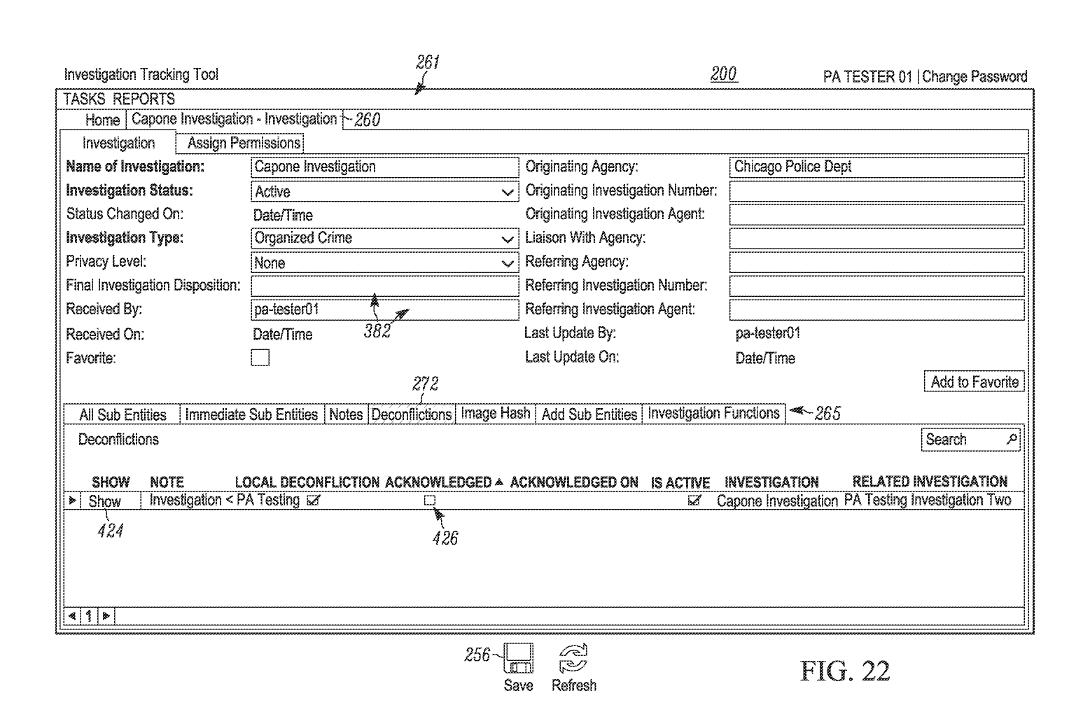

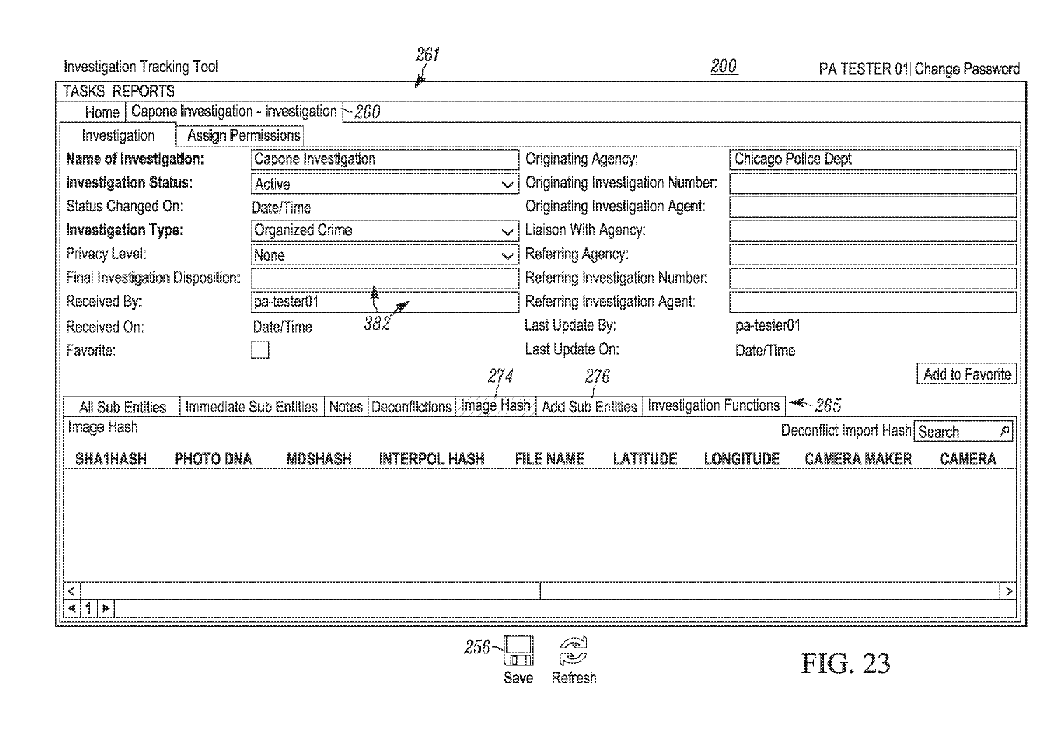

Upon saving the new investigation and corresponding data via input 256, a new investigation tracking module 261 is created (FIG. 7). Investigation tracking module 261 may correspond to second investigation module 44 of FIG. 2, for example. A data portfolio (e.g., portfolio 66 of FIG. 2) is created in memory 62 of computing device 38 to store the investigation data entered under tab 240. Further, an investigation module tab 260 is created and opened, as illustrated in FIG. 7, to provide user access to module 261. Tab 260 includes two sub-tabs including an Investigation tab 262 and an Assign Permissions tab 264. Under Investigation tab 262 of FIG. 7, the investigation data entered via fields 382 of FIG. 6 is displayed and may be edited. In addition, additional tabs 265 provide read/write access to further investigation data associated with investigation tracking module 261. In particular, sub entities tab 266 lists all entities that are associated with module 261, i.e., entities that are linked directly or indirectly (through other entities) to module 261. Immediate sub entities tab 268 lists all child entities of the investigation module 261, i.e., entities that are directly linked to the current investigation tracking module 261. Other immediate entities (not shown in FIG. 7) may be provided, including any entities that are child entities (i.e., immediately linked) to another entity in the hierarchical entity structure. For example, an immediate sub entity may be a child entity of an investigation tracking module, of another sub-entity, or of any other data entity. The entities listed under tabs 266 and 268 may be searched via search field 280. Investigation notes may be typed and saved under notes tab 270. Deconflictions associated with module 261 are listed under tab 272, as described with FIG. 22, and images (and corresponding hash values) associated with module 261 are listed under tab 274, as described with FIG. 23.

The investigation module 261 may be added to the user's favorites listing 208 (FIG. 5) via button 282. The updated investigation data of the opened investigation module 261 in tab 260 is saved and stored in the corresponding data portfolio of computing device 38 (FIG. 2) at any time via input 256.

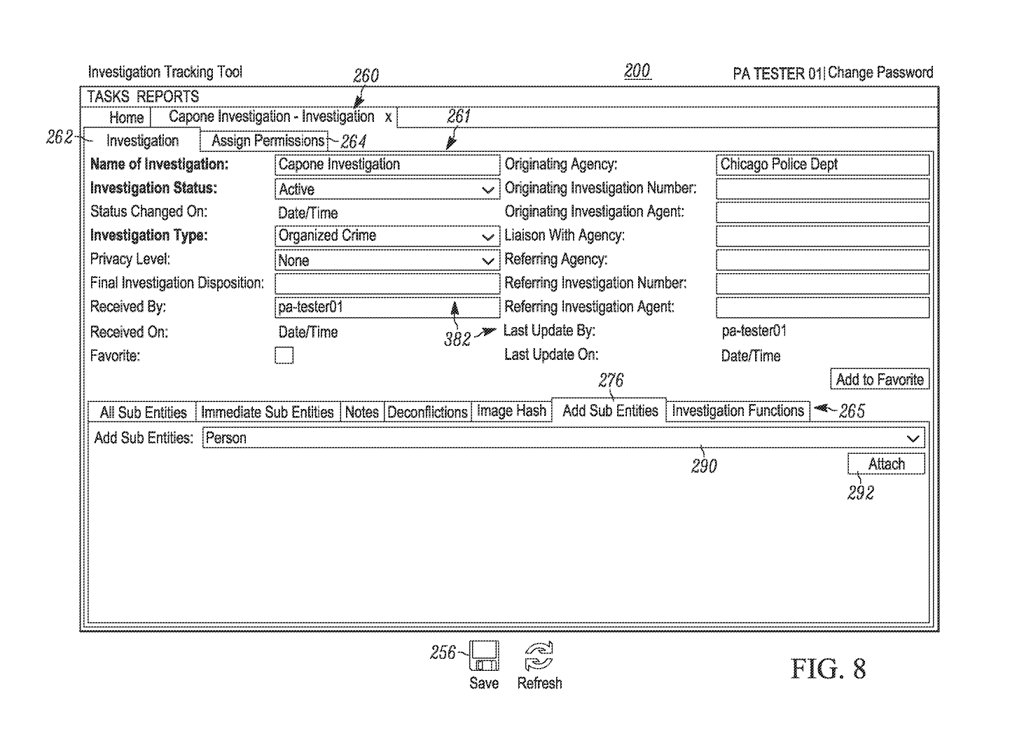

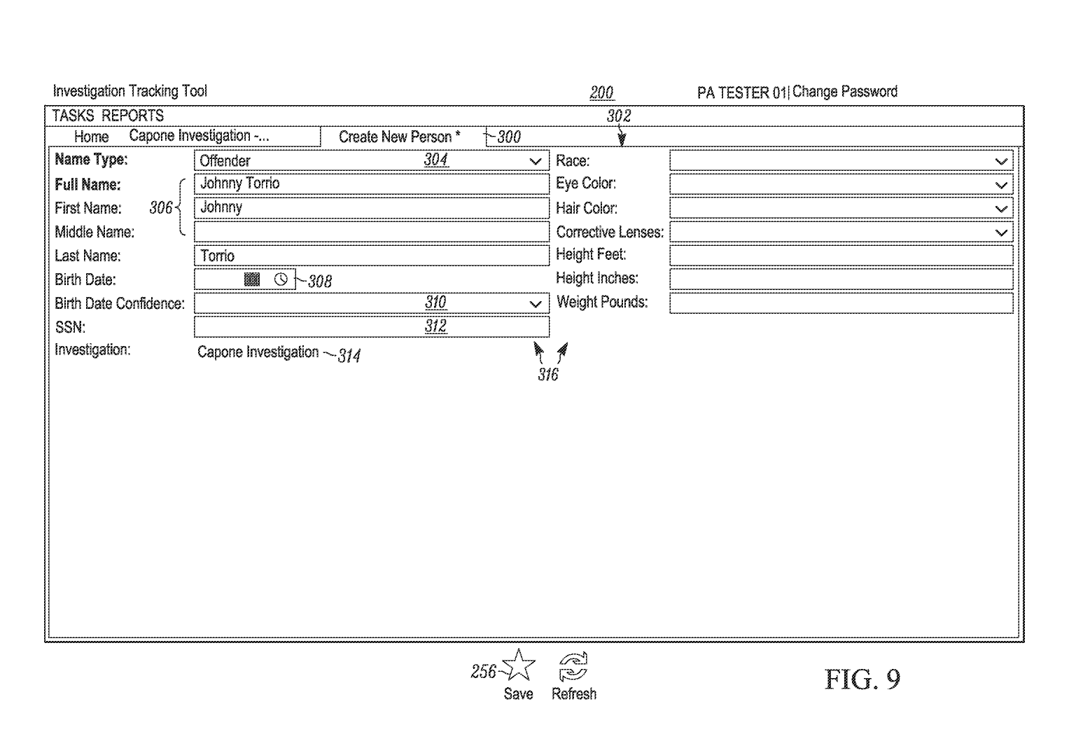

Tab 276 of FIG. 7 is selected to add new entities to the investigation tracking module 261. Referring to FIG. 8, drop down menu 290 is used to select the type of entity to be added to the investigation. As described herein, exemplary entity types include persons, personas (e.g., email address, screen name, social website account names or ID, chat room name, other online identity, nickname), businesses, home or business addresses, websites, Internet Protocol (IP) addresses, images, videos, vehicles, payment accounts, or any other types of entities associated with a law enforcement investigation. With the entity type selected (illustratively “person”), input 292 is selected to create and attach the new entity to the investigation tracking module 261. Referring to FIG. 9, data related to the new entity 302 is entered in fields 316 under tab 300. For the person entity illustrated in FIG. 9, exemplary data includes the person type (e.g., complaintant, arrestee, offender, victim, or other persons) in field 304, the person's name in fields 306 (e.g., “Johnny Torrio”), the birth date in field 308, the confidence in the birth date (e.g., probable, unknown, verified, etc.) in field 310, and social security number in field 312. The originating investigation module 261 is listed in field 314. Additional data entered in fields 316 include race, eye color, hair color, corrective lenses, height, and weight. Other suitable data may be entered.

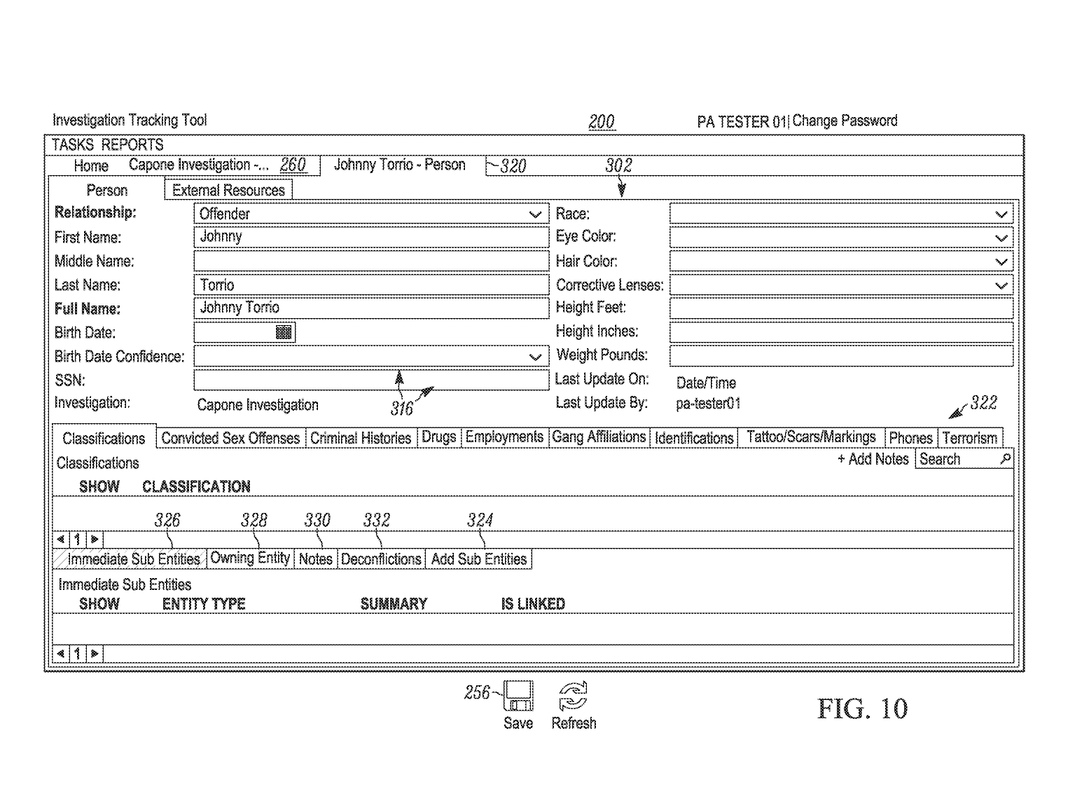

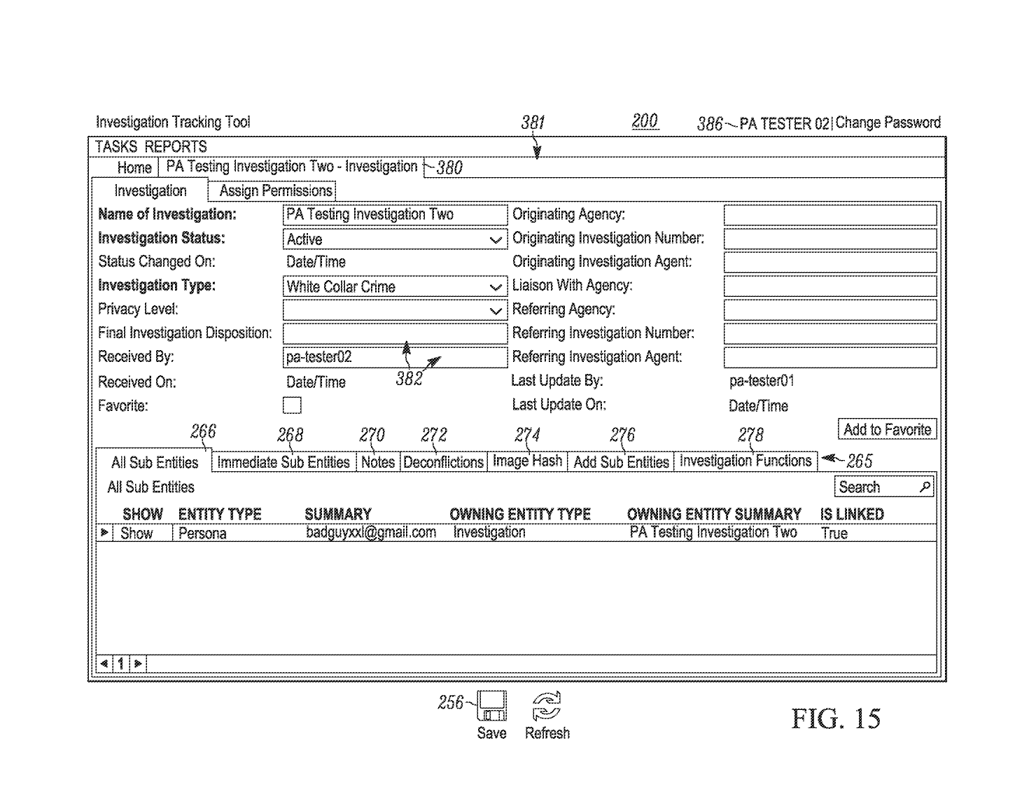

New entity 302 is saved via input 256. In one embodiment, investigation tracking logic 40 executes the deconfliction process upon a user selecting input 256 to determine if another entity of the same name (e.g., “Johnny Torrio”) exists. Since no other common entity exists, the new entity 302 is generated and displayed under tab 320 in FIG. 10 to allow further data to be entered and linked to entity 302. Additional investigation data that may be linked to entity 302 is entered under tabs 322, illustratively including classifications, convicted prior offenses (e.g., sex offenses), criminal history, drug history, employment history, gang affiliations, identifications, tattoos/scar markings, phones and phone numbers, and terrorism involvement. Further, other entities may be added under tab 324 and linked to entity 302, and these entities are displayed in the entity listing under tab 326. The new entities are added via tab 324 as described with respect to adding new entities in FIG. 9, for example. Tab 328 lists all owning entities, i.e., the corresponding investigation tracking modules that are associated with the entity 302. The owning entities for entity 302 include the investigation tracking module 261 as well as any investigation tracking modules that have been linked to entity 302 through a deconfliction process (e.g., entity 381 of FIG. 15). Notes and associated deconflictions are listed in respective tabs 330, 332.

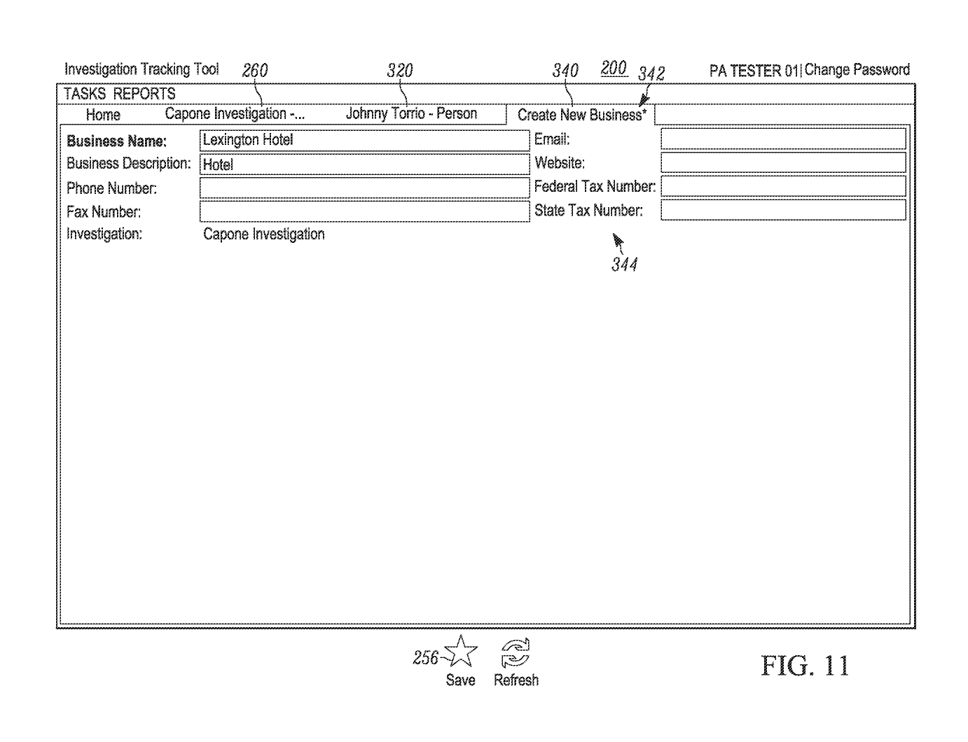

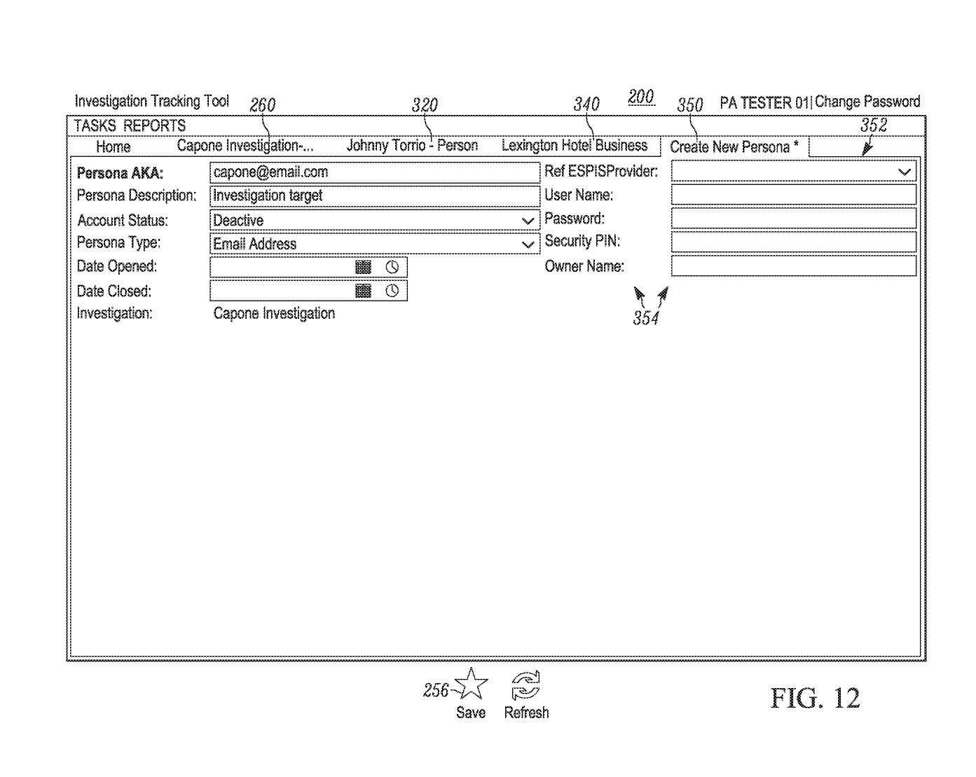

Other exemplary types of entities that may be added are illustrated in FIGS. 11 and 12, including a new business entity 342 under tab 340 (FIG. 11) and a new persona entity 352 under tab 350 (FIG. 12). Exemplary data entered into fields 344 for business entity 342 of FIG. 11 include the business name (illustratively “Lexington Hotel”), the business description, the phone/fax numbers, the associated investigation tracking module, email, website, and tax numbers. Exemplary data entered into fields 354 for persona entity 352 of FIG. 12 include the persona type (e.g., chat room name, online identity, email, social media website identity, nickname, screen name, etc.), the persona name or AKA (also known as), the description, the status of the persona if an online account is involved (e.g., deactive, active, etc.), the internet service provider, the dates the account were open/closed, the user name/password/PIN of the account, etc.

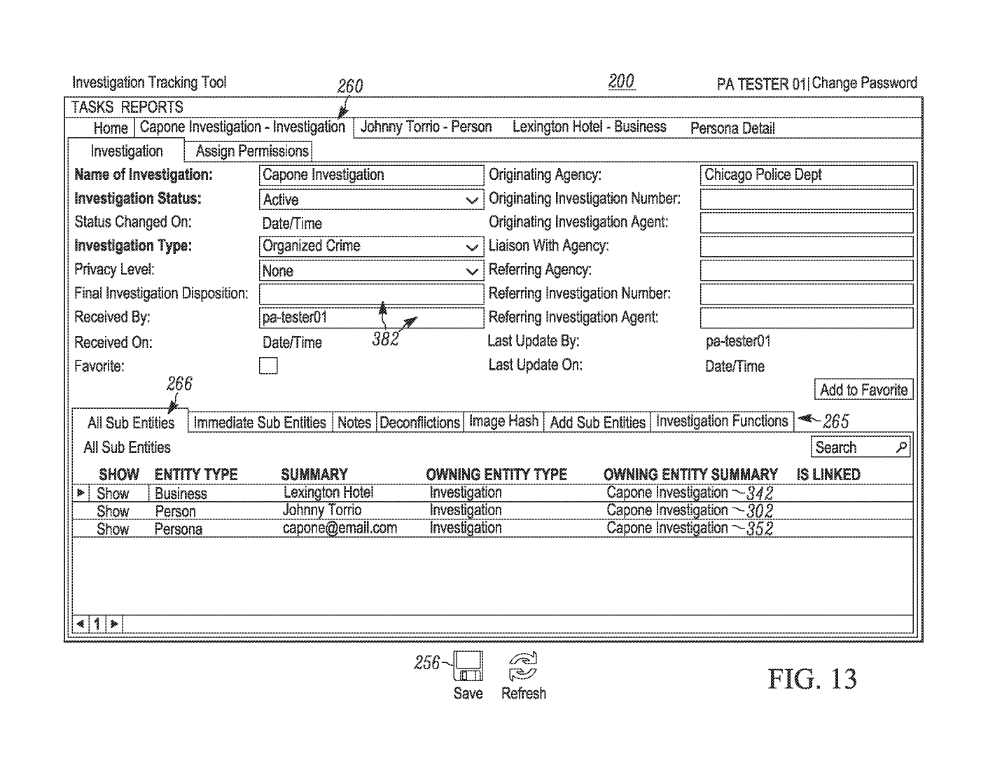

Referring to FIG. 13, all three newly created entities 302, 342, 352 are listed under the sub entities tab 366 of the investigation tracking module 261. Each entity 302, 342, 352 may be accessed via sub entities tab 366 for viewing and/or editing (i.e., select “show” next to each listed entity 302, 342, 352).

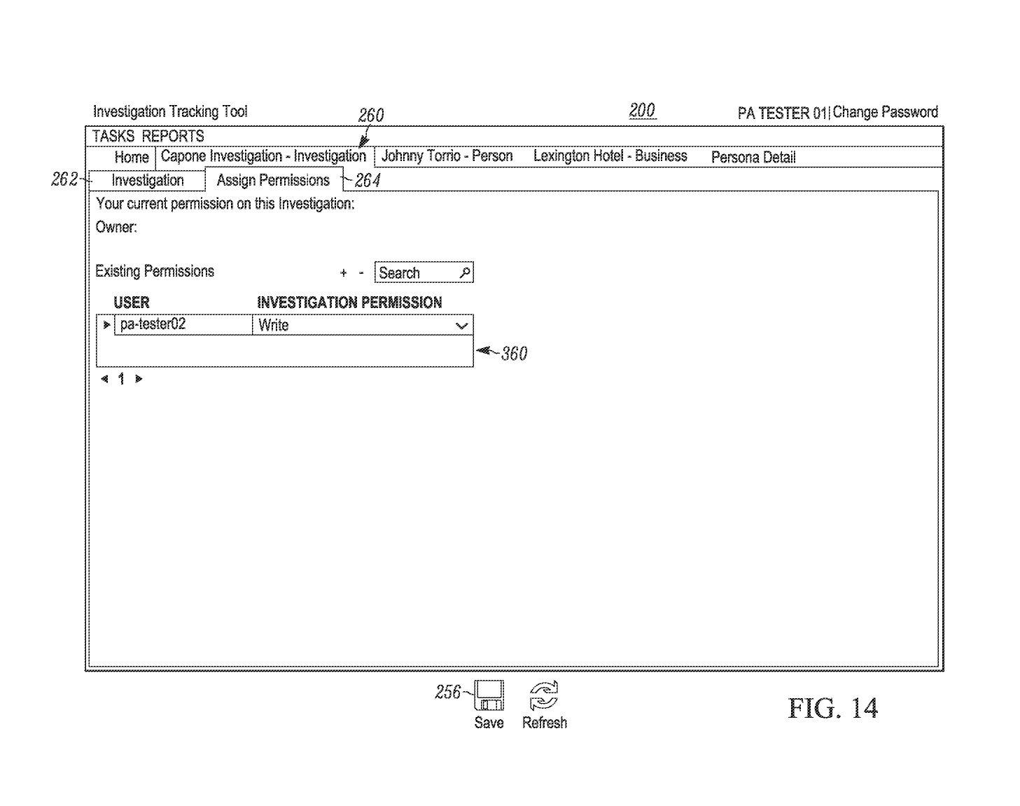

Referring to FIG. 14, user permissions may be added and edited under the Assign Permissions tab 264 of the investigation tracking module 261. As such, access rights may be granted to the investigation tracking module 261 for particular users and/or agencies/jurisdictions. A listing of all users that may open and access the investigation tracking module 261 are displayed in listing 360.

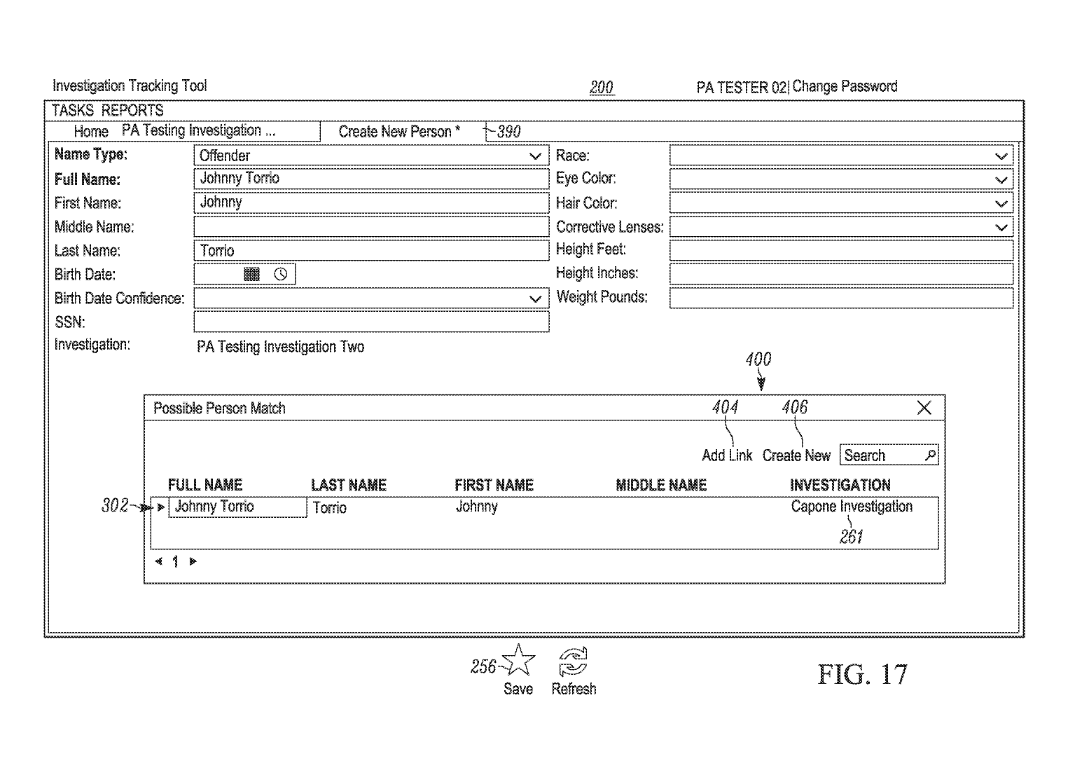

Referring to FIG. 15, a second user 386 is illustratively logged into the investigation tracking tool and accessing another investigation tracking module 381 via tab 380. Investigation tracking module 381 may correspond to first investigation tracking module 42 of FIG. 2. Investigation tracking module 381 includes the same data fields 382 and tabs 265 as investigation tracking module 261 of FIGS. 6 and 7 for entering investigation data. A single entity having the “persona” type is listed under sub entities tab 266. Upon selecting tab 276 to add a new entity to the second investigation and selecting an entity type of “person” (e.g., see FIG. 8), a Create New Person tab 390 is opened. As illustrated, the name Johnny Torrio is added to the data fields 316, which is the same name as the person of entity 302 in FIGS. 9 and 10. Upon selecting input 256 to save the new entity in the investigation tracking module 381, a deconfliction window 400 is generated in FIG. 17 to notify the user that another entity or entities (entity 302) exist with a common name. The matched entity 302 is listed in window 400 along with the corresponding investigation module where the matching entity 302 originated (module 261). The user is given the option to add a link to the existing entity 302 in module 381 via input 404 (and delete the new entity information entered under tab 390) or to create a new entity with the entity data entered under tab 390. In one embodiment, the user is given the option to add a link to entity 302 only if proper access permissions are granted to the user. Alternatively, any user may be allowed to link to the entity 302, but read/write access may be restricted based on permissions.

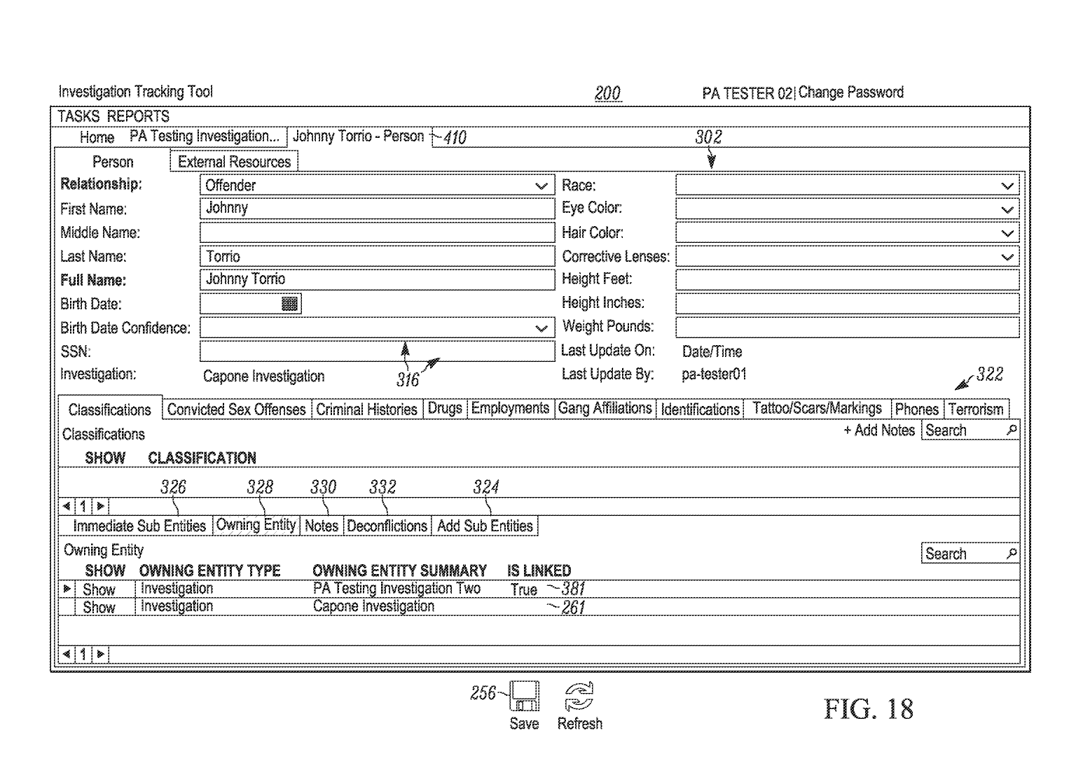

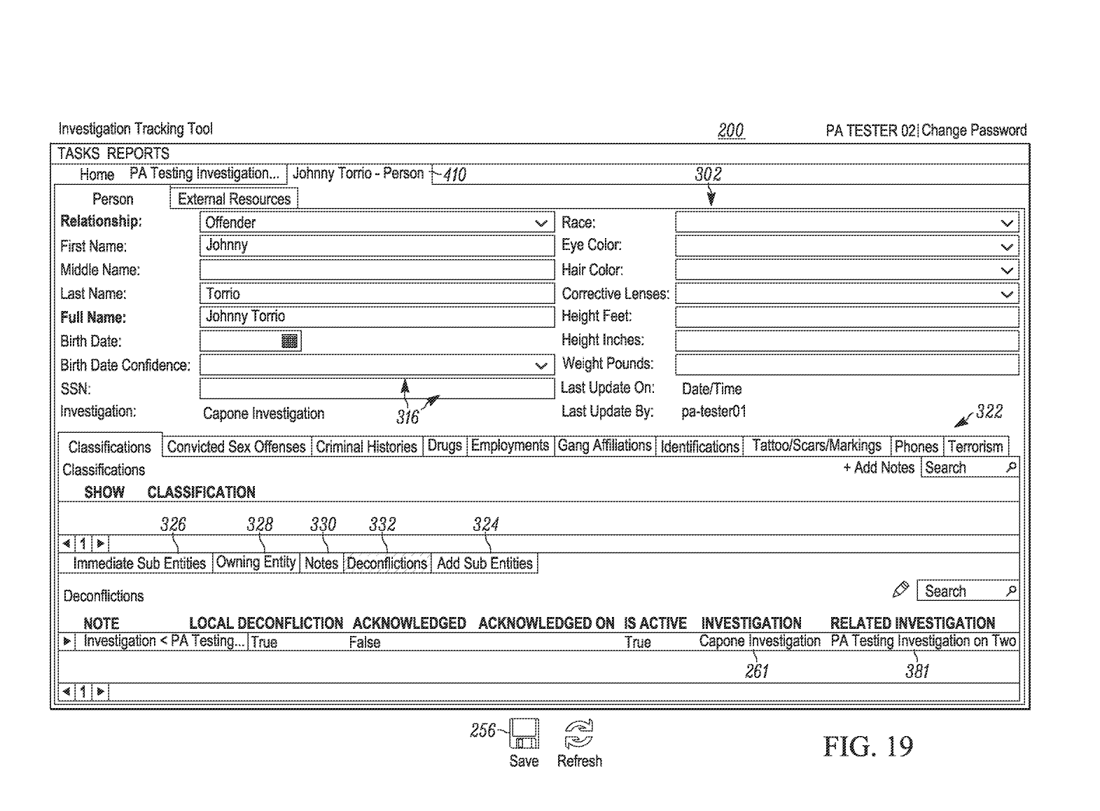

Upon selecting the add link input 404 in FIG. 17, the entity 302 is opened and accessible by the user via module 381 under tab 410, as illustrated in FIG. 18. The user may be granted read and/or write access to the data in fields 316 and 322 depending on the user access permissions granted by the originating investigation module 261 (e.g., see FIG. 14). The investigation tracking modules associated with entity 302 are listed under owning entity tab 328 and illustratively include modules 261 and 381. In FIG. 19, the deconflictions tab 332 identifies the entity 302 as being linked to module 381 and as being originated with module 261. Tab 332 also identifies the deconfliction as being a local deconfliction and indicates whether the deconfliction has been acknowledged at the originating module 261 (e.g., see input 426 of FIG. 22).

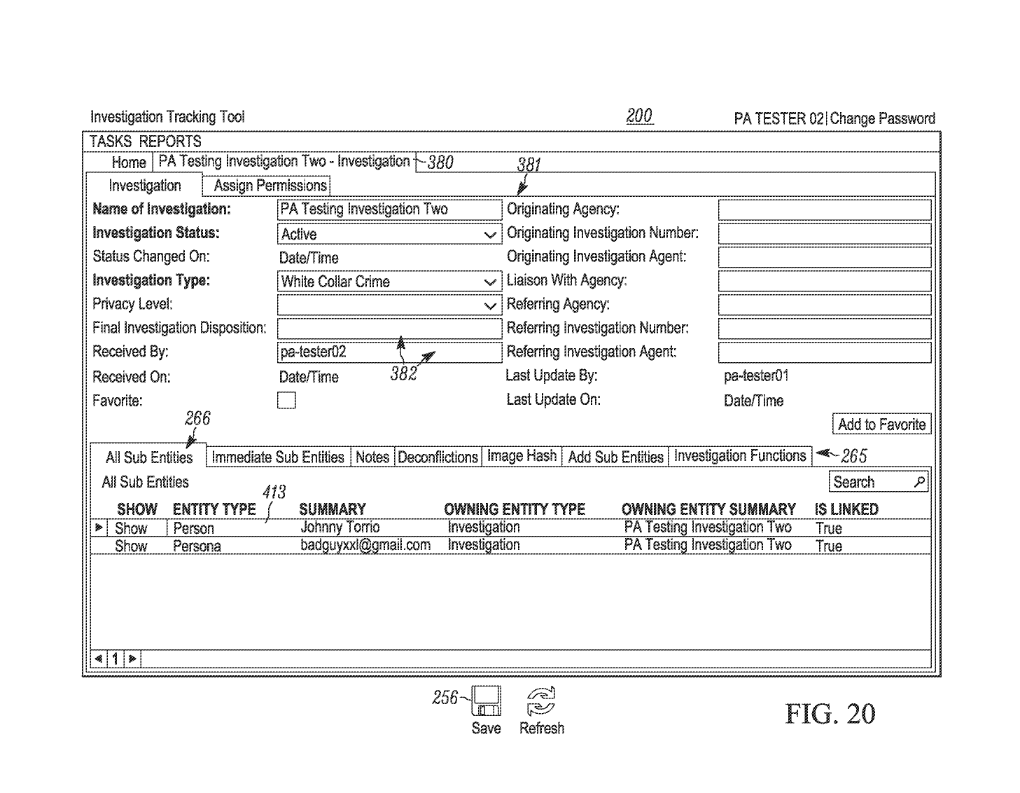

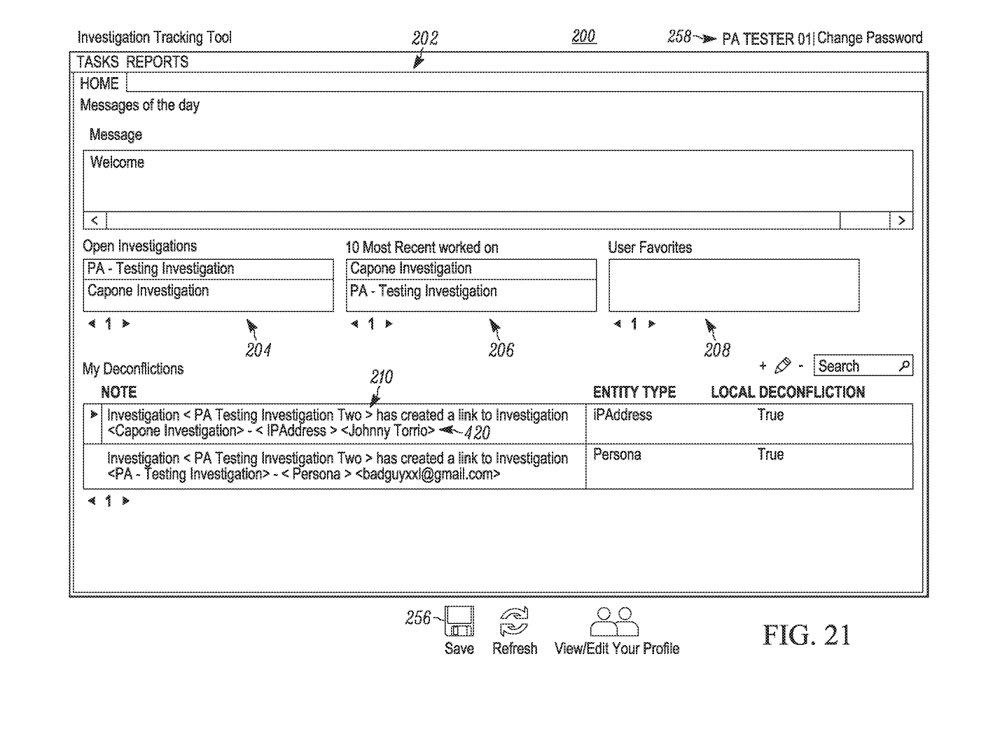

The newly linked entity 302 is also added to the list of entities under sub entities tab 266 of FIG. 15. See, for example, the link 413 illustrated in FIG. 20. In one embodiment, link 413 includes selectable data (e.g., text) that, upon selection, provides user access to the linked entity 302. In addition, upon detecting the entity match in FIG. 17, investigation tracking logic 40 sends a deconfliction notification to users of the originating investigation tracking module 261 that a matching entity in another investigation has been detected. For example, FIG. 21 illustrates the home screen 202 of user 258 showing the deconfliction 420 that occurred for the name Johnny Torrio in table 210. In addition, a deconfliction notification 424 is sent to the investigation tracking module 261 and is displayed under the deconflictions tab 272 of module 261, as illustrated in FIG. 22. The deconfliction may be acknowledged by the user by selecting box 426, which sends an indication to the second module 381 that the deconfliction was acknowledged at the first module 261 (i.e., the Acknowledged column in FIG. 19 changes from False to True). The related investigation (module 381) where the deconfliction occurred is also displayed in tab 272 of FIG. 22.

Referring to FIG. 23, an image hash tab 274 of investigation tracking module 261 is illustratively selected. Image hash tab 274 lists all image hashes that are associated with module 261. When images or videos are added as a sub entity (e.g., via tab 276), investigation tracking logic 40 generates a hash value to identify the image/video which is stored at hash library server 12. In one embodiment, investigation tracking logic 40 works in conjunction with multimedia analysis logic 48 to generate the hash value and store the hash value at server 12. Exemplary data stored for images listed under tab 274 of FIG. 23 includes the hash value (e.g., SHA1, MD5, PhotoDNA type), the file name, the camera maker and type, and other relevant image data. In one embodiment, investigation tracking logic 40 uses the SHA-1 hash type for images, videos, and text, although other suitable hash protocols may be used (e.g., MD5, SHA-256, PhotoDNA, etc.).

In one embodiment, investigation tracking logic 40 is operative to generate a map provided on the graphical user interface 200 illustrating location information of various entities associated with an investigation tracking module. For example, a map is generated with selectable pins or markers to visualize locations associated with each entity (e.g, business location, home address of person, prior crime location, etc.). As such, the entities associated with an investigation may be correlated to each other based on relevant location data associated with each entity. Further, investigation tracking logic 40 is operative to generate investigation reports to summarize and list the investigation data for each investigation. In addition, investigation tracking logic 40 is operative to generate investigation and legal documents including search warrants, activity reports, summons, subpoenas, and other relevant documents based on the investigation data provided with the investigation management tool.

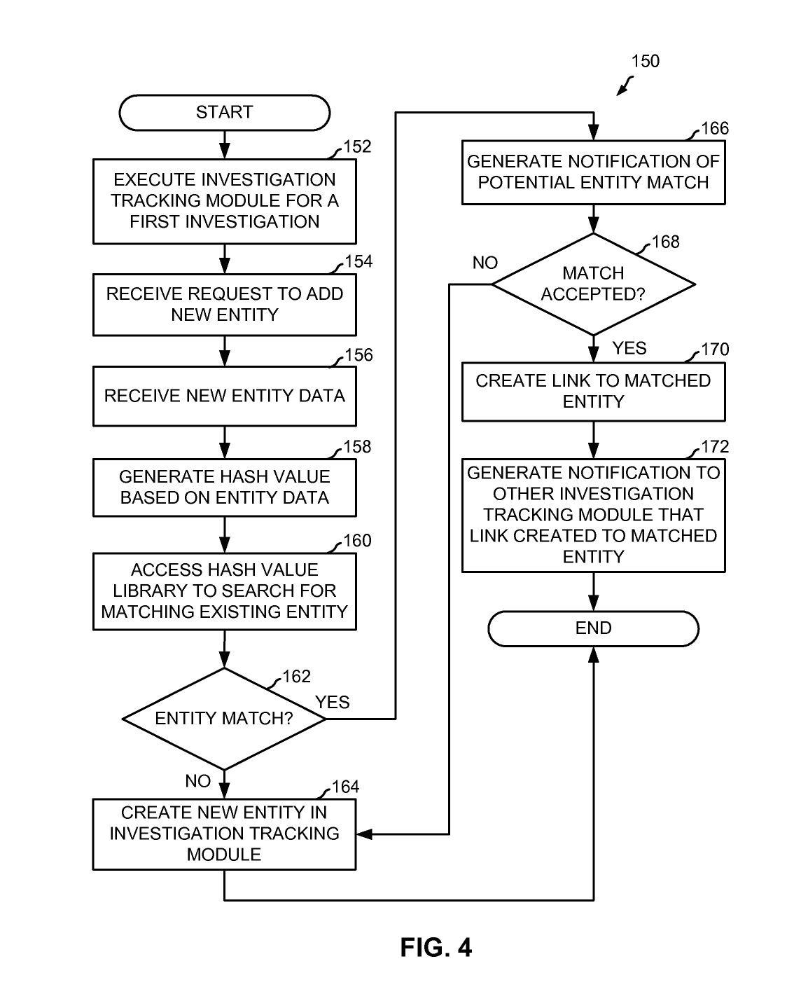

Referring now to FIG. 4, an exemplary detailed deconfliction process 150 performed by investigation tracking logic 40 and hash library server 12 is illustrated. Reference is made to FIGS. 5-23 throughout the description of FIG. 4. At block 152, investigation tracking logic 40 executes an investigation tracking module 261 (or module 381) for a first investigation (FIG. 7). At block 154, investigation tracking logic 40 receives a request to add a new entity 302 to the module 261 based on input 292 of FIG. 8. At block 156, the new entity data is received via fields 316 of FIG. 9. At block 158, in response to a user requesting to save the new entity data via input 256 of FIG. 9, investigation tracking logic 40 (or server 12) generates a hash value based on the received new entity data. At block 160, investigation tracking logic 40 accesses the hash value library of server 12 to determine if a prior-created entity matches the requested new entity 302 based on a comparison of the hash values. If a matching entity is not found at server 12 in block 162, investigation tracking logic 40 at block 164 creates a new entity 302 and stores the new entity 302 with investigation tracking module 261, as illustrated in FIG. 10.

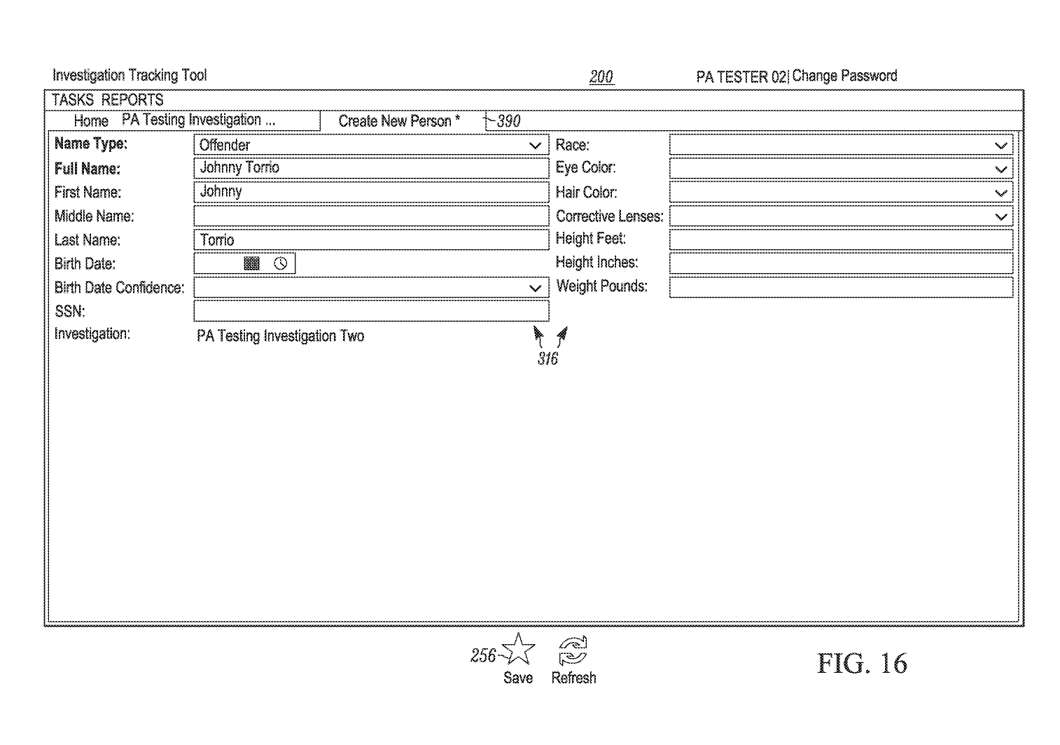

If at block 162 a matching entity is found at server 12, a deconfliction notification is generated at block 166. For example, the request to generate a new person entity in the investigation tracking module 381 of FIG. 16 results in the deconfliction notification 400 of FIG. 17. At block 168, investigation tracking logic 40 determines if the deconfliction match is accepted based on a user's selection of the link input 404 in FIG. 17. If the match is accepted, investigation tracking logic 40 generates a link to the matched entity (illustratively entity 302 in FIG. 17) in the corresponding investigation tracking module 381 (see tab 410 of FIG. 18 and the link 413 in sub entities tab 266 of FIG. 20). In addition, investigation tracking logic 40 generates and sends a notification to investigation tracking module 261 to indicate that an entity match was found and a link was created (see 420, 424 of FIGS. 21 and 22).

The disclosed operations set forth herein may be carried out by one or more suitable processors that are in communication with non-transitory computer readable medium such as but not limited to CDROM, RAM, other forms of ROM, hard drives, distributed memory, etc. The non-transitory computer readable medium stores executable instructions that when executed by the one or more processors cause the one or more processors to perform, for example, the operations of investigation tracking logic 40 and multimedia analysis logic 48 described herein and/or the methods as described with reference to FIGS. 3-23.

While the embodiments have been described as having preferred designs, the disclosed embodiments can be further modified within the spirit and scope of this disclosure. This application is therefore intended to cover any variations, uses, or adaptations of the embodiments using its general principles. Further, this application is intended to cover such departures from the present disclosure as come within known or customary practice in the art to which this disclosure pertains and which fall within the limits of the appended claims.

What is claimed is:

1. A management method for a law enforcement investigation carried out by one or more computing devices, the method comprising:
executing, by investigation tracking logic, a first investigation tracking module of a plurality of investigation tracking modules, each investigation tracking module being operative to track a set of investigation data for a different law enforcement investigation, each set of investigation data including entity data;
receiving, by the investigation tracking logic, first entity data associated with the first investigation tracking module;
comparing, by the investigation tracking logic, the first entity data to investigation data associated with a second investigation tracking module; and
in response to the first entity data matching second entity data associated with the second investigation tracking module, generating, by the investigation tracking logic, a link in the first investigation tracking module to the second entity data associated with the second investigation tracking module.

2. The method of claim 1, further comprising providing a notification to the second investigation tracking module that the second entity data matches the first entity data.

3. The method of claim 1, further comprising deleting the first entity data in response to the generating the link to the second entity data.

4. The method of claim 1, further comprising generating a first hash value based on the received first entity data, the first entity data matching the second entity data based on the first hash value matching a second hash value associated with the second entity data, the first and second hash values each including a string of text characters.

5. The method of claim 4, the comparing further comprising accessing a hash library stored on a remote server to identify the second hash value, the hash library containing a plurality of hash values associated with entity data from a plurality of investigation tracking modules provided on a plurality of different communication networks.

6. The method of claim 5, further comprising, if the first hash value does not match a hash value in the hash library, storing the first hash value associated with the first entity data in the hash library and linking the stored first hash value to the first entity data of the first investigation tracking module.

7. The method of claim 1, wherein the first entity data is received based on user input received via a user interface, and the first entity data includes a text string.

8. The method of claim 7, further comprising generating selectable notification data provided at the user interface to notify a user that the first entity data matches the second entity data, and the generating the link is further in response to a user selection received via the user interface of the selectable notification data.

9. The method of claim 7, wherein the first entity data includes at least one of person data, persona data, business data, and address data.

10. The method of claim 1, wherein the link provides the user read/write access to the second entity data of the second investigation tracking module at the first investigation tracking module, and wherein changes to the second entity data made at the second investigation tracking module are shared with the first investigation tracking module.

11. The method of claim 1, wherein the link is generated further in response to a verification by the investigation tracking logic that a current user of the first investigation tracking module has access rights to investigation data associated with the second investigation tracking module.

12. The method of claim 1, wherein the first investigation tracking module provided on a first computing device located on a first communication network, and the second investigation tracking module is provided on a second computing device located on a second communication network remote from the first communication network.

13. A management system for a law enforcement investigation comprising:
investigation tracking logic operative to execute a first investigation tracking module of a plurality of investigation tracking modules, each investigation tracking module being operative to track a set of investigation data for a different law enforcement investigation, each set of investigation data including entity data, the investigation tracking logic being operative to
receive first entity data associated with the first investigation tracking module;
compare the first entity data to investigation data associated with a second investigation tracking module; and
in response to the first entity data matching second entity data associated with the second investigation tracking module, generate a link in the first investigation tracking module to the second entity data associated with the second investigation tracking module.

14. The system of claim 13, the investigation tracking logic being further operative to provide a notification to the second investigation tracking module that the second entity data matches the first entity data.

15. The system of claim 13, the investigation tracking logic being further operative to delete the first entity data in response to generating the link to the second entity data.

16. The system of claim 13, the investigation tracking logic being further operative to generate a first hash value based on the received first entity data, the first entity data matching the second entity data based on the first hash value matching a second hash value associated with the second entity data, the first and second hash values each including a string of text characters.

17. The system of claim 16, the investigation tracking logic comparing the first entity data by accessing a hash library stored on a remote server to identify the second hash value, the hash library containing a plurality of hash values associated with entity data from a plurality of investigation tracking modules provided on a plurality of different communication networks.

18. The system of claim 17, wherein if the first hash value does not match a hash value in the hash library, the investigation tracking logic instructs the remote server to store the first hash value associated with the first entity data in the hash library and link the stored first hash value to the first entity data of the first investigation tracking module.

19. The system of claim 13, wherein the first entity data is received based on user input received via a user interface, the first entity data includes a text string, the investigation tracking logic further generates selectable notification data provided at the user interface to notify a user that the first entity data matches the second entity data, and the link is generated further in response to a user selection received via the user interface of the selectable notification data.

20. The system of claim 13, wherein the link provides the user read/write access to the second entity data of the second investigation tracking module at the first investigation tracking module, and wherein changes to the second entity data made at the second investigation tracking module are shared with the first investigation tracking module.

21. The system of claim 13, wherein the investigation tracking logic executes the first investigation tracking module on a first computing device located on a first communication network, and the second investigation tracking module is located on a second computing device located on a second communication network remote from the first communication network.

22. A non-transitory computer-readable medium comprising:
executable instructions such that when executed by at least one processor cause the at least one processor to:
execute a first investigation tracking module of a plurality of investigation tracking modules, each investigation tracking module being operative to track a set of investigation data for a different law enforcement investigation, each set of investigation data including entity data;
receive first entity data associated with the first investigation tracking module;
compare the first entity data to investigation data associated with a second investigation tracking module; and
in response to the first entity data matching second entity data associated with the second investigation tracking module, generate a link in the first investigation tracking module to the second entity data associated with the second investigation tracking module.

23. The non-transitory computer-readable medium of claim 22, wherein the executable instructions further cause the at least one processor to provide a notification to the second investigation tracking module that the second entity data matches the first entity data.

24. The non-transitory computer-readable medium of claim 22, wherein the executable instructions further cause the at least one processor to generate a first hash value based on the received first entity data, the first entity data matching the second entity data based on the first hash value matching a second hash value associated with the second entity data, the at least one processor comparing the first entity data to the investigation data associated with the second investigation tracking module by accessing a hash library stored on a remote server to identify the second hash value associated with the second entity data, the hash library containing a plurality of hash values associated with entity data from a plurality of investigation tracking modules provided on a plurality of different communication networks.

25. The non-transitory computer-readable medium of claim 22, wherein the executable instructions further cause the at least one processor to provide a graphical user interface, wherein the first entity data is received based on user input received via the graphical user interface, the first entity data includes a text string, wherein the graphical user interface comprises selectable notification data to notify a user that the first entity data matches the second entity data, and the link is generated further in response to a user selection received via the graphical user interface of the selectable notification data.

26. The non-transitory computer-readable medium of claim 22, wherein the link is operative to provide the user read/write access to the second entity data of the second investigation tracking module at the first investigation tracking module, and wherein changes to the second entity data made at the second investigation tracking module are shared with the first investigation tracking module.

27. The non-transitory computer-readable medium of claim 22, wherein the at least one processor is provided on a first computing device located on a first communication network, and the second investigation tracking module is adapted for execution by a different processor provided on a second computing device located on a second communication network remote from the first communication network.
